(19) United States
(12) Patent Application Publication
(10) Pub. No.: US 2020/0282594 A1
(43) Pub. Date: Sep. 10, 2020

(54) Print head coater module for a 3D printer, use of the print head coater module and 3D printer including the print head coater module

(71) Applicant: ExOne GmbH, Gersthofen (DE)

(72) Inventors: Roland Ladewig, Windeby (DE); Michael Fischer, Markt Indersdorf (DE); Thomas Huber, Aichach (DE)

(21) Appl. No.: 16/808,649

(22) Filed: Mar. 4, 2020

(30) Foreign Application Priority Data
Mar. 8, 2019 (EP) 19 161 573.1

(51) Int. Cl. B28B 1/00; B33Y 30/00

(52) U.S. Cl. CPC B28B 1/001; B33Y 30/00

(57) ABSTRACT

Disclosed is a print head coater module 10 for a 3D printer, comprising a print head 12, a coater 14 having a container 16 defining an inner cavity 18 for receiving particulate material and opening into an output opening from which the particulate material can be output, and a roller assembly 20 arranged between the container 16 and the print head 12, and a common support structure 22 to which the print head 12, the container 16 and the roller assembly 20 are attached, so that the print head 12, the container 16 and the roller assembly 20 can be moved together over a construction space of the 3D printer.

The present invention relates to a print head coater module for a 3D printer, the use of the print head coater module and a 3D printer including the print head coater module.

Various generative manufacturing processes (and consequently various types of 3D printers, i.e. machines/constructions for building up a component in layers) are known.

Some generative manufacturing processes have the following steps in common:
(1) First, particulate material (and particulate construction material, respectively) is applied over the entire surface of/continuously on a construction field, so as to form a layer of unsolidified particulate material.
(2) The applied layer of unsolidified particulate material is selectively solidified in a predetermined partial area (in accordance with the component part to be manufactured), for example by selectively printing a treatment agent, for example a binder (alternatively, for example, by laser sintering).
(3) Steps (1) and (2) are repeated to manufacture a desired component. For this purpose, a construction platform on which the component is built up in layers may, for example, be lowered by respectively one layer thickness before a new layer is applied (alternatively, the coater and the printing device may, for example, be raised by respectively one layer thickness).
(4) Finally, the manufactured component which is formed by the solidified partial areas and is supported and surrounded by loose, unsolidified particulate material may be unpacked.

The construction space in which the component or the components is/are manufactured may, for example, be defined or formed by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An example of such a construction box is, for example, described in DE 10 2009 056 696 A1. However, the construction space may, for example, also be free at the side (at least in part), i.e. unlimited at the circumference (at least in part). An upper area of the construction space may, for example, be referred to as a construction field.

A coater (also referred to as a “recoater”) is normally used in the above step (1). Various coaters are known for use in 3D printers, by means of which a particulate construction material may be applied to the construction field (also referred to as construction surface or construction area) in the form of a uniform layer over the entire surface/a continuous layer.

One type of coater uses a roller (short: “roller coater”) in front of which first an amount of particulate construction material is put down before coating and which is then horizontally moved across the construction field to apply the particulate construction material in the form of a uniform layer onto the construction field. In this respect, the roller may be rotated opposite to the moving direction.

Another kind of coater (a so-called “container coater”, for example a “slot coater”) uses a container which defines an inner cavity for receiving particulate material, and has an output region (for example an elongated output region), for example comprising an (for example elongate) output slot, for outputting the particulate construction material. The container coater may, for example, be displaceable across a construction field or a construction space (for example horizontally, for example transverse to its longitudinal direction), wherein the particulate material can be output onto the construction field through the (elongate) output region to thereby apply a uniform/continuous construction material layer over the entire surface of the construction field. The coater may be elongate, for example to span or to cover the length or width of a (rectangular) construction field or construction space. The coater may, for example, be provided with a stroking/sweeping member by which construction material applied to the construction field may be stroked, to compress and/or level the construction material.

In the above step (2), a printing device having a print head may for example be used, which applies a treatment agent in a controlled way onto a partial area of the construction material layer applied before. The treatment agent contributes to a (direct and/or later) solidification of the particulate material layer in the partial area. For example, the treatment agent may be/contain a binder, for example a binder component of a multicomponent binder.

Alternatively, a laser may, for example, be used in the above step (2) to solidify a partial area of the construction material layer applied previously, in particular by sintering or melting the construction material in the partial area.

There are various approaches to increase the throughput of 3D printed components or 3D printers. DE 10 2014 112 447 A1 proposes a 3D printer including two construction spaces, each of which has respectively one coater assigned to it and is operated by a common/shared print head. Alternatively, the desired components could be printed simultaneously/in parallel in two separate 3D printers with one construction space each, to which a coater and a print head is assigned.

It may be considered as being an object of the invention to provide a 3D printer and/or a device for the same, by means of which high-quality components can be produced effectively.

For this purpose, the present invention provides a print head coater module for a 3D printer according to claim 1, the use of a print head coater module according to claim 9 and a 3D printer according to claim 10. Further configurations of the print head coater module are described in dependent claims 2-8. Further configurations of the 3D printer are described in dependent claims 11-13.

According to various aspects of the invention, a print head coater module for a 3D printer has a print head, a coater including a container defining an inner cavity for receiving particulate material (for example, sand particles, for example, metal particles, for example, plastic particles) and opening into an output opening from which the particulate material can be discharged (for example, to a/the construction field of the 3D printer, for example, in the direction of a/the construction space of the 3D printer, for example continuously during a journey over a/the construction space of the 3D printer) (for example by means of a dosing mechanism, for example comprising a dosing roller and/or an ultrasonic device and/or a shaker device), and a roller assembly arranged between the container and the print head, and a common (for example frame-shaped) support structure to which the print head, the container and the roller assembly are attached, so that the print head, the container and the roller assembly can be moved over a construction space of the 3D printer together.

The arrangement of print head and coater in one module makes it possible that several construction spaces arranged one after the other are served by both the same print head and the same coater in succession. Since each construction space is served by the same coater and the same print head, a uniform quality of the 3D printed components can be achieved in the different construction spaces, so that eventually high-quality components can be manufactured or deficient products or complex adjustment work can be reduced or eliminated. Compared to the initially described approaches to increase the throughput of 3D printed components or 3D printers, one or more coaters can be saved in addition, which are otherwise/to date assigned to a particular construction space. Finally, by using such a coater in the module, comprising a container and a roller assembly (instead of, for example, a coater including a container and a stroking/sweeping blade), the coating speed can be increased, which otherwise would be a limiting factor for the speed of the print head coater module. The roller assembly is thus able to compensate, at least to some extent, for any loss of printing speed that would otherwise be associated with combining into a module. In this respect, the container may primarily assume the function of outputting a controlled quantity, the roller assembly being able to assume the function of (fine) distribution and compression, i.e. said functions may be separated from each other.

For example, the print head, the container, the output opening and/or the roller assembly may be elongated. The output opening may, for example, be located on a side of the coater facing the construction space. The container may, for example, comprise a closing device, for example to close the output opening (tightly and/or completely), for example such that no particulate material is output from the output opening.

The roller assembly may, for example, comprise a first roller and a second roller. The first roller may, for example, be arranged between the container and the second roller. For example, the second roller may be arranged between the first roller and the print head. For example, the first roller and/or the second roller may be elongated. For example, the first roller may be a distribution roller. For example, the first roller may be configured to distribute particulate material output from the container, for example (evenly) over the construction field (i.e., over a/the upper region of the construction space). The second roller may, for example, be a compression roller. The second roller may, for example, be configured to compress particulate material output from the container (and distributed by the first roller), for example evenly, for example to a predetermined degree of compression.

By using a first roller and a second roller in the roller assembly, the coating speed may be (further) increased. The first roller may (evenly) distribute particulate material output from the container over the construction field (i.e. the upper region of the construction space) and the second roller may compress the particulate material distributed by the first roller (to a desired degree of compression). This means that the first roller may assume the function of distributing the particulate material and the second roller may assume the function of compressing the particulate material. These functions may thus be separated from each other, which allows the coating speed to be increased.

The first roller may, for example, comprise a structured surface. The structured surface of the first roller may, for example, comprise one or more recesses. For example, the structured surface of the first roller may comprise one or more protrusions. The recesses and/or protrusions may, for example, be formed by removing material from a part of a/the surface of a/the roller and/or by applying material to a part of a/the surface of a roller.

By structuring the surface of the first roller, the particulate material output from the container can be particularly well distributed. By structuring the surface of the first roller, a particularly even distribution of the particulate material over the construction field can be achieved.

The structure of the surface of the first roller may, for example, comprise at least one groove (for example elongated, for example formed by recesses and/or protrusions), for example a plurality of grooves, for example 2-40 grooves, for example 2-30 grooves, for example 2-20 grooves, for example 2-10 grooves. The at least one groove may, for example, be inclined relative to the roller longitudinal axis, for example in the form of a helix winding around a/the roller longitudinal axis. The at least one groove may, for example, form the above-mentioned recess(es).

The structure of the surface of the first roller may, for example, comprise a honeycomb structure (formed by recesses and/or protrusions, for example), for example a diamond-shaped honeycomb structure.

The second roller may comprise a smooth surface, for example. For example, the surface of the second roller may have a roughness Rz (average surface roughness) of less than/equal to 250 μm, for example less than/equal to 200 μm, for example less than/equal to 150 μm, for example less than/equal to 100 μm, for example less than/equal to 75 μm, for example less than/equal to 50 μm, for example less than/equal to 25 μm, for example less than/equal to 10 μm, for example less than/equal to 5 μm, for example less than/equal to 1 μm, for example less than/equal to 0.5 μm, for example less than/equal to 0.1 μm, for example less than/equal to 0.01 μm. The surface of the second roller may, for example, be coated. The coating may, for example, be made of Teflon, hard metal, ceramic and/or combinations thereof. The surface of the second roller may, for example, be ground, polished, smoothed and/or lapped.

The smooth surface of the second roller allows the particulate material to be compressed particularly well. Due to the smooth surface of the second roller, the particulate material can be compressed in a particularly even way.

The first roller and/or the second roller may, for example, be a hollow roller. The first roller and/or the second roller may for example be made of metal, plastic, steel, stainless steel, aluminum, titanium, glass fiber reinforced plastic (GRP), carbon fiber reinforced plastic (CFRP) and/or combinations thereof. The first roller and/or the second roller may, for example, have a diameter in the range of 5-500 mm, for example in the range of 10-400 mm, for example in the range of 20-300 mm, for example in the range of 30-200 mm.

The second roller may, for example, be height-adjustable in relation to the support structure (for example, adjustable in a z-direction, for example, adjustable in a vertical direction). The height adjustment may be done manually, for example, or by means of a lift drive integrated in the print head coater module. The print head coater module may, for example, have a control device that is configured to control the lift drive, for example so that the second roller is adjustable in a height direction (for example in a z-direction, for example in a vertical direction) relative to the support structure.

The roller longitudinal axis of the first roller and the roller longitudinal axis of the second roller may, for example, be (substantially) parallel to each other.

For example, the print head coater module may have its own support structure drive integrated into the print head coater module for moving the support structure along a rail system. The support structure drive may, for example, be an electric motor that drives wheels or other output means arranged on the support structure. For example, the print head coater module may have a/the control device configured to control the carrier structure drive, for example so that the carrier structure or print head coater module is movable along a/the rail system.

For example, the print head coater module may comprise an integrated first roller rotary drive for rotational movement of the first roller. For example, the first roller rotary drive may rotationally move the first roller in a direction of rotation opposite to the direction of movement of the support structure and/or the print head coater module. The first roller rotary drive may rotationally move the first roller, for example in a counter direction. For example, the print head coater module may comprise a/the control device that is configured to control the first roller rotation drive, for example in a way that the first roller can be rotationally moved in a direction of rotation opposite to the direction of movement of the support structure and/or the print head coater module, for example in a way that the first roller can be rotationally moved in a counter direction.

A rotational movement in a direction of rotation opposite to the direction of movement of the support structure and/or a rotational movement in a counter direction is understood as being a rotational movement which is opposite to a direction of rotation in which a freely rotating roller would rotate if the print head coater module was/is moved over a surface.

For example, the print head coater module may have an integrated second roller rotary drive for rotational movement of the second roller. For example, the second roller rotary drive may rotationally move the second roller in a direction of rotation opposite to and/or in the direction of the direction of movement of the support structure and/or the print head coater module. The second roller rotary drive may, for example, rotationally move the second roller in the counter direction and/or in the running direction. The print head coater module may, for example, have a/the control device configured to control the second roller rotary drive, for example in a way that the second roller can be moved rotationally in a direction of rotation opposite to and/or in the direction of the direction of movement of the support structure and/or the print head coater module, for example in a way that the second roller can be moved rotationally in the counter direction and/or in the running direction.

A rotational movement in a direction of rotation in the direction of the direction of movement of the support structure and/or a rotational movement in the running direction is understood as being a rotational movement corresponding to a direction of rotation in which a freely rotating roller would rotate if the print head coater module was/is moved over a surface.

If the second roller is rotationally moved in a direction of rotation in the direction of the direction of movement of the support structure and/or in the running direction, the particulate material can be compressed particularly well.

The print head coater module may, for example, comprise an integrated second roller lift drive for height-adjusting (for example, in the z direction, for example, adjusting in the vertical direction) of the second roller (relative to the support structure). The print head coater module may for example have a/the control device adapted to control the lift drive, for example so that the second roller is adjustable in a height direction (for example in the z direction, for example in the vertical direction) (relative to the support structure).

The print head and/or the container and/or the roller assembly may, for example, each be attached immovably (for example rigidly) to the support structure in a horizontal plane (for example in an x direction and a y direction, for example in an x/y plane). This means that the print head and/or the container and/or the roller assembly may, for example, be arranged on the support structure so that they are not movable (for example, not displaceable) in a horizontal direction.

For example, the print head may be configured to apply a treatment agent (for example a binder, for example a binder agent) in a controlled way to a partial region of a layer of particulate material previously applied by the coater. The treatment agent may, for example, contribute to an (immediate and/or subsequent) solidification of the particulate material layer in the partial region. For example, the treatment agent may be/contain a binder agent, for example a binder component of a multicomponent binder. For example, the print head may be a binder jetting print head.

For example, the print head and/or the container may be segmentable (in a longitudinal direction). This means that the print head and/or the container may, for example, consist of several segments which are arranged one after the other, for example in the longitudinal direction. The container may, for example, comprise a/the closing device. For example, the closing device may be segmentable (in a longitudinal direction). This means that the closing device may, for example, consist of several (closing) segments, which are, for example, configured to (tightly) close a partial region of the output opening.

The print head coater module may, for example, be a bidirectionally configured print head coater module that is configured to coat and/or print in two directions of travel. The bidirectionally configured print head coater module may, for example, comprise a print head and two coaters, each with one container and one roller assembly, wherein, for example, the print head may be located between the two roller assemblies, and the print head and the two roller assemblies may be located between the two containers, wherein, for example, each roller assembly may comprise a first roller and a second roller, wherein, for example, the print head may be located between the two second rollers, the print head and the two second rollers may be located between the two first rollers, and the print head, the two first rollers and the two second rollers may be located between the two containers. The bidirectionally configured print head coater module may, for example, be configured with two print heads, a container and two roller assemblies, wherein, for example, the container may be located between the two roller assemblies, and the container and the two roller assemblies may be located between the two print heads, wherein, for example, each roller assembly may comprise a first roller and a second roller, wherein, for example, the container may be located between the two first rollers, the container and the two first rollers may be located between the two second rollers, and the container, the two first rollers and the two second rollers may be located between the two print heads. The elements/components (for example, print head and/or coater and/or container and/or roller assembly and/or support structure and/or first roller(s) and/or second roller(s)) of the bidirectionally configured print head coater module may, for example, be configured as described above.

The print head coater module may, for example, be used for applying in layers and selectively printing layers of sand, such as foundry sand. The print head coater module may, for example, be used for 3D printing of casting molds and/or foundry cores. The print head coater module may, for example, be used for collective applying in layers and selectively printing particulate material in several construction fields arranged in series, for example formed by a respective construction platform, which is, for example, received in a respective construction box.

According to various aspects of the invention, a 3D printer has a print head coater module according to any one of the aspects described above, a plurality of construction spaces arranged one after the other in series, and a rail system along which the print head coater module can be moved across the plurality of construction spaces.

The construction spaces may, for example, each define an elongate construction field (for example, a rectangular construction field) and may be arranged one after the other in series in such a way that the construction fields are aligned with their longitudinal axes one after the other and/or in extension of each other, for example without spacing, for example, directly one after the other. The longitudinal axes of the construction fields may, for example, be congruent. The rail system may, for example, comprise one or more rails (for example two rails) whose longitudinal axes extend (essentially) parallel to the longitudinal axes of the construction fields. The print head coater module may, for example, be displaceable (for example along the one or more rails) in a direction that is (essentially) parallel to the longitudinal axes of the construction fields.

For example, in a top view, the construction spaces may have two long sides and two short sides and may, for example, be arranged adjacent to each other along a (respectively) short side, for example without any spacing, for example directly next to each other. The rail system may, for example, have one or more rails (for example two rails) whose longitudinal axes extend, for example, (essentially) parallel to the long sides of the construction spaces. The print head coater module may, for example, be displaceable (for example along the one or more rails) in a direction that is (essentially) parallel to the long sides of the construction spaces.

The arrangement of the construction spaces allows the lengths of the components (such as the print head and/or roller assembly) of the print head coater module to be reduced. This means that, for example, shorter roller(s) (assemblies) and/or shorter print heads can be used. This makes it possible to reduce deflection of the roller(s) (assembly), which improves the quality of the 3D printed components. In addition, a shorter print head can be used, which is less expensive.

A construction space may, for example, be formed by a construction box. For example, a construction box may have a height-adjustable construction platform. A construction box may, for example, have side walls. The construction spaces may, for example, be arranged adjacent to each other in such a way that two adjacent construction boxes have a common side wall. The common side wall may, for example, be removable, so that two adjacent construction spaces are connectable to form a larger construction space. The common side wall may, for example, form a partition between two (adjacent) construction spaces. The construction platforms of the respective construction spaces may, for example, be independently height-adjustable.

For example, the 3D printer may have a channel structure (for example in the form of a gutter) that extends underneath the plurality of construction boxes. The construction boxes may, for example, be configured to discharge loose particulate material downwards into the channel structure. The channel structure may, for example, be inclined and/or may comprise a particulate material conveyor device (for example a conveyor belt).

For example, the 3D printer may comprise a first and a second turning device located at a/the first and a/the second longitudinal end of the series of construction spaces (or construction boxes), respectively, and configured to turn the print head coater module so that after a first journey over the construction spaces (and/or construction boxes), the print head coater module is ready for a second journey over the construction spaces (and/or construction boxes) in the reverse direction. The turning device may, for example, be a turn table or a turning platform.

The 3D printer and/or the print head coater module may, for example, comprise a control device that controls the print head coater module so that it coats and prints during a first journey over the construction spaces (and/or construction boxes) and performs an idle run during a second journey over the construction spaces (and/or construction boxes) which takes place in the opposite direction to the direction of the first journey.

The 3D printer and/or the print head coater module may, for example, comprise a/the control device that controls the print head coater module in a way to coat during a first journey over the construction spaces (and/or construction boxes) and to print during a second journey over the construction spaces (and/or construction boxes) which takes place in the opposite direction to the direction of the first journey.

For example, the 3D printer and/or the print head coater module may have a control device (for example, a common control device) that is configured to perform the above-mentioned control functions.

For example, the 3D printer may comprise a return path connecting the first longitudinal end of the series of construction spaces (and/or construction boxes) to the second longitudinal end of the series of construction spaces (and/or construction boxes) to return the print head coater module to the first longitudinal end after a first journey over the construction spaces (and/or construction boxes) starting from the first longitudinal end towards the second longitudinal end during which the print head coater module coats and prints.

For example, the print head coater module may be configured bidirectionally to coat and print during both a first journey and a second journey over the construction spaces (and/or construction boxes). The bidirectionally configured print head coater module may, for example, comprise one print head and two coaters, each formed by a container and a roller assembly. The bidirectionally configured print head coater module may, for example, comprise two print heads, a container and two roller assemblies.

Exemplary but non-limiting embodiments of the present invention are shown in the Figures and are hereinafter described in detail.

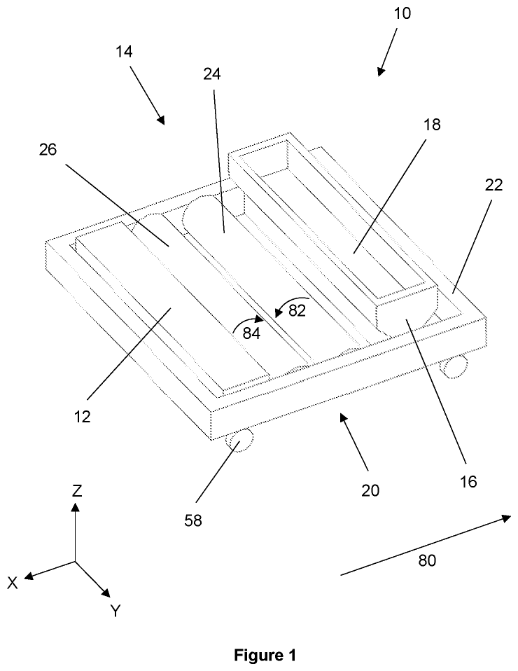

FIG. 1 shows a perspective view of a print head coater module for a 3D printer according to a first embodiment.

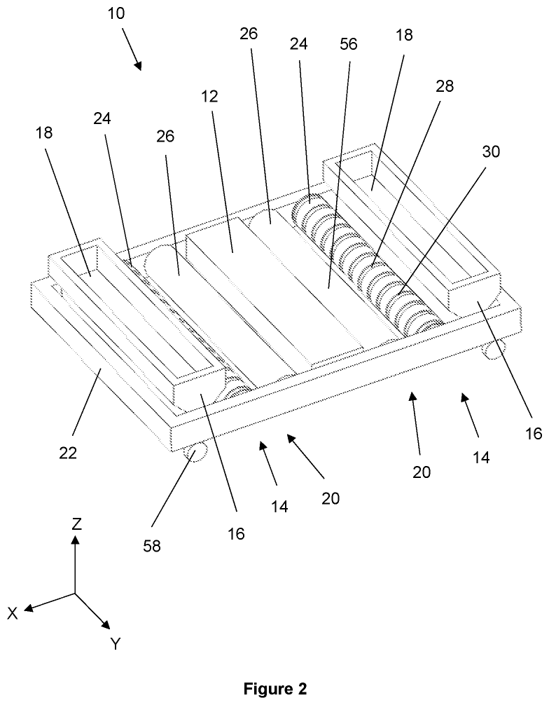

FIG. 2 shows a perspective view of a print head coater module for a 3D printer according to a second embodiment.

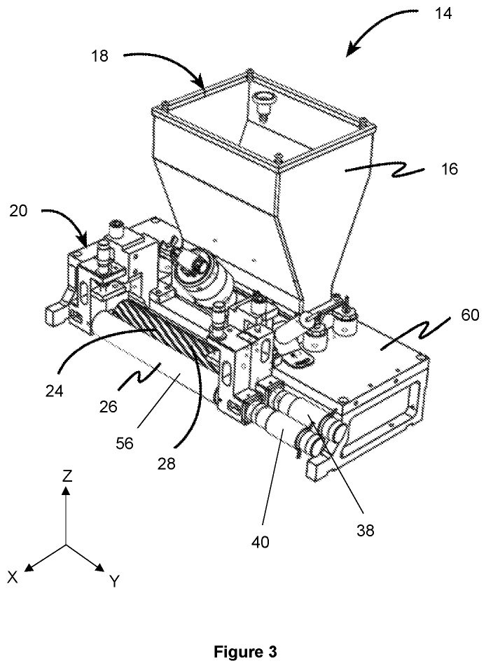

FIG. 3 shows a perspective view of a coater that can be used in the print head coater module according to the first and/or second embodiment.

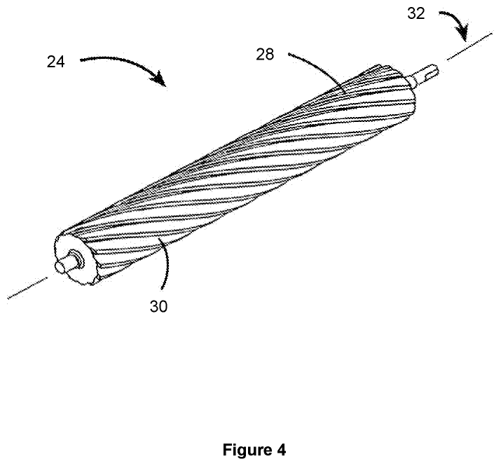

FIG. 4 shows a perspective view of a first roller that can be used in the print head coater module of the first and/or second embodiment and/or in the coater shown in

FIG. 3.

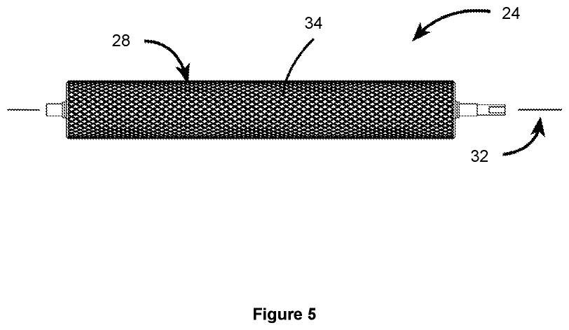

FIG. 5 shows a front view of another first roller that can be used in the print head coater module according to the first and/or second embodiment and/or in the coater shown in FIG. 3.

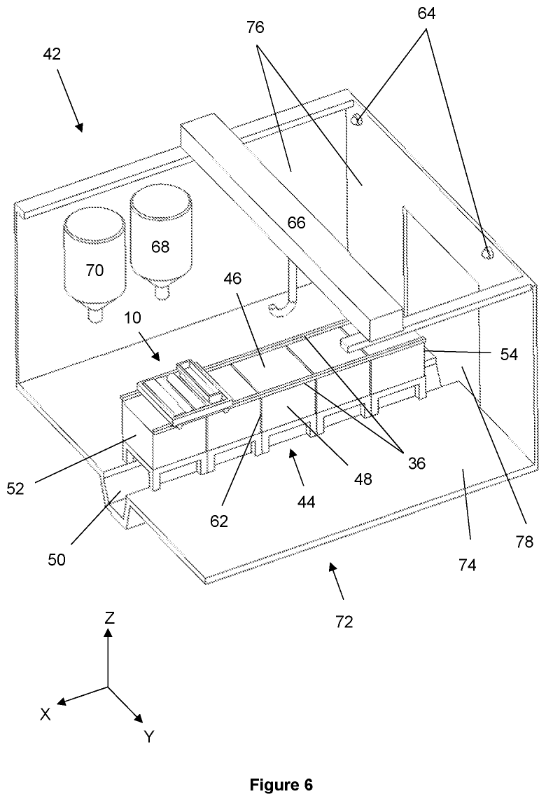

FIG. 6 shows a perspective view of a 3D printer according to a third embodiment in which the print head coater module according to the first embodiment is used.

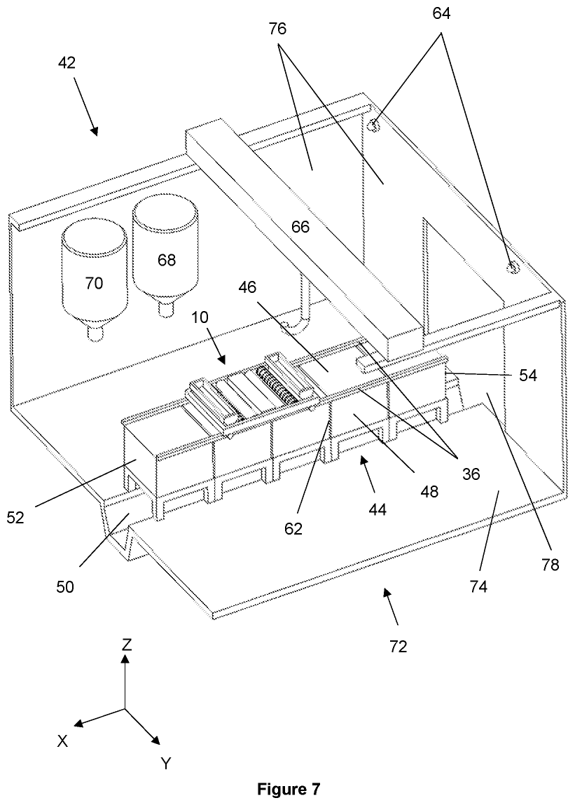

FIG. 7 shows a perspective view of a 3D printer according to a fourth embodiment in which the print head coater module according to the second embodiment is used.

In the following detailed description, reference is made to the enclosed Figures which are incorporated therein and in which specific embodiments are shown by way of illustration, according to which the invention can be performed. In this respect, the terms indicating a direction, such as “up”, “down”, “front”, “rear”, etc. are used with reference to the orientation in the described Figure(s). As components of embodiments may be positioned in a number of different orientations, the terminology indicating the different directions serves for illustration and shall not be restrictive in any way.

It shall be understood that other embodiments may be used and structural or logical changes may be made without deviating from the scope of protection of this invention. It goes without saying that the features of the various exemplary embodiments described herein may be combined unless specified otherwise. Thus, the following detailed description should not be understood in a restrictive sense and the scope of protection of this invention shall be defined by the attached claims.

In this description, terms such as “connected”, “attached” and “coupled” may be used to describe both a direct and indirect connection, a direct or indirect attachment and a direct or indirect coupling.

In the Figures, identical or similar elements are provided with identical reference numbers where appropriate.

FIG. 1 shows a perspective view of a print head coater module 10 for a 3D printer 42 according to a first embodiment. FIG. 2 shows a perspective view of a print head coater module 10 for a 3D printer 42 according to a second embodiment. FIG. 3 shows a perspective view of a coater 14 that can be used in the print head coater module 10 according to the first and/or second embodiment. FIG. 4 shows a perspective view of a first roller 24 that can be used in the print head coater module 10 according to the first and/or second embodiment and/or in the coater 14 shown in FIG. 3. FIG. 5 shows a front view of another first roller 24 that can be used in the print head coater module 10 according to the first and/or second embodiment and/or in the coater 14 shown in FIG. 3.

As shown in FIGS. 1 and 2, the print head coater module 10 for a 3D printer 42 according to the first and/or second embodiment has a print head 12, a coater 14 with a container 16 defining an internal cavity 18 for receiving particulate material (for example sand particles, for example metal particles, for example plastic particles) and opening into an output opening, from which the particulate material can be output, and a roller assembly 20, which is arranged between the container 16 and the print head 12, and a common support structure 22, to which the print head 12, the container 16 and the roller assembly 20 are attached, so that the print head 12, the container 16 and the roller assembly 20 are displaceable together over a construction space of the 3D printer 42.

For example, the output opening may be located on the lower side of container 16. This means that, in FIGS. 1-3, for example, the output opening may be located along the z direction below the inner cavity 18, at a lower end of container 16.

As shown in FIGS. 1-3, the roller assembly 20 may, for example, comprise a first roller 24 and a second roller 26, the first roller 24 being located between the container 16 and the second roller 26.

For example, the first roller 24 may have a structure surface 28 (not shown in FIG. 1; shown in FIGS. 2-5). The second roller 26 may, for example, have a smooth surface 56 (shown in FIGS. 1-3).

For example, the structure of the surface of the first roller 24 may comprise at least one groove 30, for example a plurality of grooves 30, wherein the at least one groove 30 may optionally be inclined with respect to the roller longitudinal axis 32, for example in the form of a helix winding around the roller longitudinal axis 32. A first roller 24 with a groove 30 in the form of a helix is, for example, shown in FIG. 2, and a first roller 24 with a plurality of grooves 30 in the form of a helix is, for example, shown in FIGS. 3 and 4. Such first rollers 24 may, for example, be used in the first and/or second embodiment of the print head coater module 10 shown in FIGS. 1 and 2.

For example, the structure of the surface of the first roller 24 may comprise a honeycomb structure 34, for example a rhombus/diamond-shaped honeycomb structure 34. A first roller 24 with a honeycomb structure is shown in FIG. 5, for example. Such a first roller 24 may be used, for example, in the first and/or second embodiment of the print head coater module 10 shown in FIGS. 1 and 2.

The surface of the first roller 24 may, for example, be structured by removing material from the surface of a roller blank and/or by applying material to the surface of a roller blank.

The surface of the second roller 26 may, for example, be ground, polished, smoothed and/or lapped, for example to smooth the surface, for example to obtain a desired roughness Rz (average surface roughness) of the surface.

The second roller 26 may, for example, be height-adjustable in relation to the support structure 22. This means that the second roller 26 may, for example, be adjustable in the z direction (see FIGS. 1-3).

The print head coater module 10 according to the first and/or second embodiment may, for example, comprise its own support structure drive (not shown in the Figures) integrated into the print head coater module 10 for moving the support structure 22 or the print head coater module 10 along a rail system 36. For example, the support structure drive may drive wheels 58 arranged on the support structure 22. As an alternative or in addition to the wheels 58, other suitable output means may also be used. For example, the wheels 58 may be placed onto the rail system 36, for example so that the support structure 22 or the print head coater module 10 can be moved along the rail system 36.

The print head coater module 10 according to the first and/or second embodiment may, for example, comprise an integrated first roller rotary drive 38 for rotationally moving the first roller 24, for example in a direction of rotation opposite to the direction of movement of the support structure 22 and/or in the counter direction.

As illustrated in FIG. 1, a rotational movement of the first roller 24 in a direction of rotation opposite to the direction of movement of the support structure 22 and/or a rotational movement of the first roller 24 in a counter direction is understood as being a rotational movement in the direction of arrow 82, when the print head coater module 10 is displaced/moved in the direction of arrow 80.

The print head coater module 10 according to the first and/or second embodiment may, for example, comprise an integrated second roller rotary drive 40 for rotationally moving the second roller 26, for example in a direction of rotation in the direction of the direction of movement of the support structure 22 and/or in the direction of travel.

As illustrated in FIG. 1, a rotational movement of the second roller 26 in a direction of rotation in the direction of the direction of movement of the support structure 22 and/or a rotational movement of the second roller 26 in the direction of travel is understood as being a rotational movement in the direction of arrow 84, when the print head coater module 10 is displaced/moved in the direction of arrow 80.

For example, the print head coater module 10 according to the first and/or second embodiment may comprise an integrated second roller lift drive for height-adjusting the second roller 26 (not shown in the Figures).

For example, the print head 12 and/or the container 16 and/or the roller assembly 20 may each be attached immovably/rigidly to the support structure 22 in a horizontal plane (i.e., in a/the x/y plane in FIGS. 1 and 2). However, the print head 12 and/or the container 16 and/or the roller assembly 20 may, for example, be attached to the support structure 22 to be displaceable/movable in the z direction and/or tiltable along a respective longitudinal axis (axes) and/or turnable and/or rotatable.

As shown in FIG. 3, the coater 16 may for example comprise a coater support structure 60 to which the container 16, the roller assembly 20 (and/or the first roller 24 and/or the second roller 26), the first roller rotary drive 38 and/or the second roller rotary drive 40 may be attached. Also, the second roller lift drive may be attached to the coater support structure 60, for example (not shown in FIG. 3). For example, the coater support structure 60 may be attached to the support structure 22, for example so that the container 16, the roller assembly 20 (and/or the first roller 24 and/or the second roller 26), the first roller rotary drive 38, the second roller rotary drive 40 and/or the second roller lift drive can be attached to the support structure 22 by means of the coater support structure 60 (for example indirectly via the coater support structure 60).

The print head coater module 10 according to the first and/or second embodiment may, for example, comprise a control unit (not shown in the Figures) which is configured to control the first roller rotary drive 38, the second roller rotary drive 40 and/or the second roller lift drive, for example to control the above-described functions (for example turning/rotating and/or height-adjusting).

As shown in FIG. 2, the print head coater module 10, according to the second embodiment, may, for example, be configured to be bidirectional (to coat and/or print in both directions of travel) and may comprise a/one print head 12 and two coaters 14, each with a container 16 and a roller assembly 20, wherein, for example, the print head 12 may be located between the two roller assemblies 20 and the print head 12 and the two roller assemblies 20 may be located between the two containers 16, wherein, for example, the roller assembly 20 may comprise a first roller 24 and a second roller 26, and wherein, for example, the print head 12 may be located between the two second rollers 26, the print head 12 and the two second rollers 26 may be located between the two first rollers 24, and the print head 12, the two second rollers 26 and the two first rollers 24 may be located between the two containers 16. All elements/components (such as print head 12, coater 14, container 16, roller assembly 20, first rollers 24 and/or second rollers 26) of the bidirectionally configured print head coater module 10 according to the second embodiment may be configured as described above, for example.

An alternative embodiment (not shown in the Figures) of the print head coater module 10, which may be configured to be bidirectional, may for example comprise two print heads 12, two roller assemblies 20 and a/one container 16, wherein, for example, the container 16 may be located between the two roller assemblies 20 and the container 16 and the two roller assemblies 20 may be located between the two print heads 12, and wherein, for example, the print head 12, the container 16 and/or the roller assembly 20 may be configured as described above. Such an arrangement could be obtained, for example, by mirroring the arrangement of print head 12, roller assembly 20 and container 16 shown in FIG. 1 on a/the longitudinal axis of container 16.

The elements/components described above may be used for all embodiments of the print head coater module 10.

The print head coater module 10 may, for example, be used (a) for applying in layers and selectively printing of layers of sand, for example foundry sand, and/or (b) for 3D printing of casting molds and/or foundry cores, and/or (c) for collectively applying in layers and selectively printing particulate material in several construction fields 46 arranged in series, for example formed by a respective construction platform which is received, for example, in a respective construction box 48.

FIG. 6 shows a perspective view of a 3D printer 42 according to a third embodiment in which the print head coater module 10 according to the first embodiment is used. FIG. 7 shows a perspective view of a 3D printer 42 according to a fourth embodiment in which the print head coater module 10 according to the second embodiment is used.

As shown in FIGS. 6 and 7, a 3D printer 42 according to the third and/or fourth embodiment has a print head coater module 10 for a 3D printer, a plurality of construction spaces 44 arranged in series one after the other, and a rail system 36 along which the print head coater module 10 is displaceable across the plurality of construction spaces 44. The print head coater module 10 may, for example, be any one of the print head coater modules 10 described above, for example a print head coater module 10 according to the first embodiment (as shown in FIG. 6), for example a print head coater module 10 according to the second embodiment (as shown in FIG. 7).

A (respective) construction space 44 may, for example, be formed by a construction box 48. A (respective) construction box 48 may, for example, have a height-adjustable construction platform (not shown in the Figures) and side walls. The (respective) construction platforms of the (respective) (for example adjacent) construction boxes 48 may, for example, be independently controllable (for example height-adjustable), for example by means of a/the control device. The construction spaces 44 or the construction boxes 48 may, for example, be arranged adjacent to each other, in such a way that two adjacent construction boxes 48 have a common side wall 62. The common side wall 62 may, for example, separate the two (respective) adjacent construction spaces 44 from each other. The common side wall 62 may, for example, be removable/detachable so that two adjacent construction spaces 44 can be connected to form a larger construction space. In this case, a/the control device may be configured, for example, to synchronously control the construction platforms of the connected construction spaces 44, for example so that the construction platforms always have the same height (in a z direction in FIGS. 6 and 7). For example, it may be possible to connect more than two adjacent construction spaces 44 to form a common construction space.

The construction spaces 44 may, for example, each define an elongated construction field 46 and may be arranged in series one after the other, so that the construction fields 46 are aligned with their longitudinal axes one after the other or in extension of each other (see FIGS. 6 and 7). The longitudinal axes of the construction fields 46 may, for example, be congruent.

In a plan view, the construction spaces 44 and the construction fields 46, respectively, may have two long sides and two short sides, for example, and may be arranged, for example, adjacent to each other along a respective short side (see FIGS. 6 and 7).

The rail system 36 may, for example, comprise one or more rails. In FIGS. 6 and 7, for example, a rail system with two rails is shown. The longitudinal axis (axes) of the one or more rails may, for example, extend (substantially) parallel to the long sides of the construction spaces 44 and/or (substantially) parallel to the longitudinal axes of the construction spaces 46.

The print head coater module 10 may, for example, be displaceable along the rail system 36 (for example along the one or more rails) in a direction that is (substantially) parallel to the long sides of the construction spaces 44 and/or (substantially) parallel to the longitudinal axes of the construction fields 46 (see FIGS. 6 and 7).

The 3D-printer according to the third and/or fourth embodiment may, for example, comprise a channel structure 50 which extends underneath the plurality of construction boxes 48, wherein the construction boxes 48 may, for example, be configured to discharge loose particulate material downwards (in the z direction in FIGS. 6 and 7) into the channel structure 50. The channel structure 50 may for example optionally be inclined and/or may comprise a particulate material conveyor device (for example a conveyor belt), for example to discharge the loose particulate material.

The 3D-printer 42 according to the third and/or fourth embodiment may, for example, comprise a first and a second turning device (not shown in the Figures), arranged at a/the first longitudinal end 52 and at a/the second longitudinal end 54 of the series of construction spaces 44 and construction boxes 48, respectively, and configured to turn the print head coater module 10 so that after a first journey over the construction spaces 44 and/or construction boxes 48, the print head coater module 10 is ready for a second journey over the construction spaces 44 and/or construction boxes 48 in the reverse direction. Such a turning device is particularly suitable for the 3D printer 42 according to the third embodiment in which a print head coater module 10 according to the first embodiment is used (as shown in FIG. 6).

The 3D printer 42 according to the third and/or fourth embodiment may, for example, comprise a control device (not shown in the Figures) which controls the print head coater module 10 in such a way that it coats and prints during a first journey over the construction spaces 44 and/or construction boxes 48 and performs an idle run during a second journey over the construction spaces 44 and/or construction boxes 48, or that it coats during a first journey over the construction spaces 44 and/or construction boxes 48, and prints during a second journey over the construction spaces 44 and/or construction boxes 48, which is performed in an opposite direction to the direction of the first journey. A control device configured in this way is particularly suitable for the 3D printer 42 according to the third embodiment, in which a print head coater module 10 according to the first embodiment is used (as shown in FIG. 6).

For example, the 3D printer 42 according the third and/or fourth embodiment may have a return path (not shown in the Figures) that connects a/the first longitudinal end 52 of the series of construction spaces 44 and/or construction boxes 48 with a/the second longitudinal end 54 of the series of construction spaces 44 and/or construction boxes 48, to guide the print head coater module 10 back to the first longitudinal end 52 after a first travel over the construction spaces 44 and/or construction boxes 48 starting from the first longitudinal end towards the second longitudinal end 54, during which the print head coater module 10 coats and prints. A control device configured in this way is particularly suitable for the 3D printer 42 of the third embodiment, in which a print head coater module 10 according to the first embodiment (as shown in FIG. 6) is used.

For example, the 3D printer 42 according to the fourth embodiment may have a/the print head coater module 10 that is configured to be bidirectional to coat and print during both a first journey and a second journey (as shown in FIG. 7). For example, the print head coater module 10, which is configured to be bidirectional, may be configured as described above. The print head coater module 10, which is configured to be bidirectional, may, for example, be the print head coater module 10 according to the second embodiment. For example, the print head coater module 10, which is configured to be bidirectional, may comprise a print head 12 and two coaters 14, each with a container 16 and a roller assembly 20. For example, the print head coater module 10, which is configured to be bidirectional, may comprise two print heads 12, a container 16 and two roller assemblies 20.

For example, the 3D printer 42 according to the third and/or fourth embodiment may comprise a tank 68 for a/the treatment agent (for example binder agent, for example binder). The tank 68 may be configured, for example, to fill the print head 12 (for example automatically, for example in a way controlled by a control device) with treatment agent, for example when the level of treatment agent in the print head 12 falls below a (pre)determined limit.

The 3D-printer 42 according to the third and/or fourth embodiment may, for example, comprise a tank 70 for a/the particulate material (for example sand, for example metal powder). The tank 70 may, for example, be configured to fill the container 16 with particulate material (for example automatically, for example in a way controlled by a/the control device), for example when the level of particulate material in the container 16 falls below a (pre)determined limit.

For example, the 3D printer 42 according to the third and/or fourth embodiment may be located in a room 72. For example, the room 72 may have a floor 74 and walls 76. For example, the room 72 may have an opening 78 (for example, a door) through which the room may be entered (for example by an operator, for example to perform maintenance on the print head coater module 10 and/or the 3D printer 42) and/or through which particulate material can be removed from the room 72 (for example by means of the channel structure 50). A crane 66 may be provided in the room 72, for example to place and/or remove the print head coater module 10 on and/or from the rail system 36, and/or to remove (for example lift out) the common/shared side walls 62. In room 72, for example, cameras 64 may be arranged, for example on the walls 76 of the room 72 and/or on the ceilings (not shown in the Figures) of the room 72. The cameras 64 can be used, for example, to monitor or control a printing process of the 3D printer 42 placed in the room 72.

1. A print head coater module (10) for a 3D printer, comprising:
a print head (12),
a coater (14) including
a container (16) defining an inner cavity (18) for receiving particulate material and opening into an output opening from which the particulate material can be output, and
a roller assembly (20) arranged between the container (16) and the print head (12), and
a common support structure (22) to which the print head (12), the container (16) and the roller assembly (20) are attached, so that the print head (12), the container (16) and the roller assembly (20) are movable together over a construction space of the 3D printer.

2. The print head coater module (10) for a 3D printer according to claim 1, wherein the roller assembly (20) comprises a first roller (24) and a second roller (26), and wherein the first roller (24) is arranged between the container (16) and the second roller (26).

3. The print head coater module (10) for a 3D printer according to claim 2, wherein the first roller (24) comprises a structured surface (28) and/or wherein the second roller (26) comprises a smooth surface (56).

4. The print head coater module (10) for a 3D printer according to claim 3, wherein the structure of the surface of the first roller (24) has at least one groove (30), inclined relative to the roller longitudinal axis (32) in the form of a helix winding around the roller longitudinal axis (32), or wherein the structure of the surface of the first roller (24) has a honeycomb structure (34).

5. The print head coater module (10) for a 3d printer according to claim 1, wherein the second roller (26) is height-adjustable relative to the support structure (22).

6. The print head coater module (10) for a 3D printer according to claim 1, further comprising:
an integrated first roller rotary drive (38) for rotational movement of the first roller (24) in a direction of rotation opposite to the direction of movement of the support structure (22), and/or an integrated second roller rotary drive (40) for rotational movement of the second roller (26) in a direction of rotation in the direction of the direction of movement of the support structure (22), and/or an integrated second roller lift drive for height adjustment of the second roller (26).

8. The print head coater module (10) for a 3D printer according to claim 1, wherein the print head (12) and/or the container (16) and/or the roller assembly (20) is/are horizontally immovably attached to the support structure (22).

9. (canceled)

10. A 3D printer (42), comprising:
a print head coater module (10) for a 3D printer,
a plurality of construction spaces (44) arranged one after the other in series, and
a rail system (36) along which the print head coater module (10) is movable across the plurality of construction spaces (44),
wherein the print head module (10) comprises
a print head (12),
a coater (14) including
a container (16) defining an inner cavity (18) for receiving particulate material and opening into an output opening from which the particulate material can be output, and
a roller assembly (20) arranged between the container (16) and the print head (12), and
a common support structure (22) to which the print head (12), the container (16) and the roller assembly (20) are attached, so that the print head (12), the container (16) and the roller assembly (20) are movable together over a construction space of the 3D printer.

11. The 3D printer (42) according to claim 10,
wherein a respective construction space (44) is formed by a construction box (48), further comprising a channel structure (50) extending below the plurality of construction boxes (48), wherein the construction boxes (48) are configured to discharge loose particulate material in a downward direction into the channel structure (50), and wherein the channel structure (50) is inclined and/or comprises a particulate material conveyor device.

12. The 3D printer (42) according to claim 10, further comprising first and second turning devices arranged at the first and second longitudinal ends of the series of construction spaces (44), respectively, and configured to turn the print head coater module (10) so that after a first journey over the construction spaces (44) the print head coater module (10) is ready for a second journey over the construction spaces (44) in the reverse direction, or further comprising a control device which controls the print head coater module (10) in a way to coat and print during a first journey over the construction spaces (44) and perform an idle run during a second journey over the construction spaces (44) which is in a direction opposite to the direction of the first journey, or to coat during a first journey over the construction spaces (44) and to print during a second journey over the construction spaces 44) which is in a direction opposite to the direction of the first journey, or during which the print head coater module (10) is coating and printing, or wherein the print head coater module (10) is configured to be bidirectional to coat and print both during a first journey and a second journey over the construction spaces (44), with a print head (12) and two coaters (14), each comprising a container (16) and a roller assembly (20), or with two print heads (12), a container (16) and two roller assemblies (20).

13. The 3D printer (42) according to claim 10, wherein the construction spaces (44) define a respectively elongate construction field (46) and are arranged one after the other in series in such a way that the construction fields (46) are aligned with their longitudinal axes one after the other and/or in extension with respect to one another.
